(19) United States
(12) Patent Application Publication
(10) Pub. No.: US 2021/0182871 A1
(43) Pub. Date: Jun. 17, 2021

(54) POST-PROCESSING METHOD AND DEVICE BASED ON COPYRIGHT REGISTRATION INFORMATION, APPARATUS, AND MEDIUM

(71) Applicant: BAIDU ONLINE NETWORK TECHNOLOGY (BEIJING) CO., LTD., Beijing (CN)

(72) Inventors: Yan ZHANG, Beijing (CN); Haitao HUANG, Beijing (CN); Xinjie HUANG, Beijing (CN); Xiaohao WANG, Beijing (CN)

(21) Appl. No.: 16/758,829

(22) PCT Filed: Jan. 28, 2019
(86) PCT No.: PCT/CN2019/073378

§ 371 Date: Apr. 23, 2020

(30) Foreign Application Priority Data
Jun. 25, 2018 (CN) 201810662615.9

(51) Int. Cl. G06Q 30/00; G06Q 50/18; G06F 16/951; G06F 16/23; G06F 21/60; H04L 9/08; H04L 9/30

(52) U.S. Cl. CPC G06Q 30/0185; G06Q 50/184; G06F 16/951; G06Q 2220/00; G06F 21/602; H04L 9/0825; H04L 9/3073; G06F 16/2379

(57) ABSTRACT

Embodiments of the present disclosure provide a post-processing method and device based on copyright registration information, an apparatus and a medium. The method is applicable to a copyright service platform, and includes: obtaining the copyright registration information; obtaining at least two participant information and post-processing information of a copyright post-processing operation, based on the copyright registration information; and sending the at least two participant information and the post-processing information as a transaction request into a blockchain network to request to add into a block for storage.

### CROSS-REFERENCE TO RELATED APPLICATIONS

This application is a US national application of International Application No. PCT/CN 2019/073378, filed on Jan. 28, 2019, which is based upon and claims priority to Chinese Patent Application No. 201810662615.9, filed on Jun. 25, 2018, the entire contents of which are incorporated herein by reference.

### TECHNICAL FIELD

The present disclosure relates to blockchain network technologies, for example, to a post-processing method and apparatus based on copyright registration information, a device, and a medium.

### BACKGROUND

After an author creates original works such as written works, oral works, musical works, comedic works, quyi works, dance works, acrobatic works, fine arts works, photography works, engineering design drawings, product design drawings, maps, schematic drawings, model works, architectural works and film works, etc., the author generally needs to register and confirm the copyright of his/her works at the first time, and then use them publicly.

After the copyright registration and confirmation, in addition to the author's own use, transaction operations such as copyright assignment and permission may generally be involved, or there may be illegal use without the permission of the author, the author needs to protect his/her rights based on copyright registration information, that is, there may be many post-processing operation requirements based on the copyright registration information.

Among the copyright transaction and protection solutions, some are performed offline, and some are performed online. The offline solution, i.e., private negotiation between both parties, has relatively transparent negotiation content, but it is obviously inefficiency, and especially in the Internet era, there is a large amount of original information on the Internet, it is sometimes difficult to obtain information of the author, and one by one negotiation is also time-consuming. The online solution, i.e., post-processing operations performed by an Internet service platform, has the problem that the post-processing operation is transparent, for example, the transaction price is not in public, and the rights protection evidence is difficult to confirm.

### SUMMARY

Embodiments of the present disclosure provide a post-processing method based on copyright registration information, and the method is applied to a copyright service platform. The method includes: obtaining the copyright registration information; obtaining at least two participant information and post-processing information of a copyright post-processing operation based on the copyright registration information; and sending the at least two participant information and the post-processing information as a transaction request into a blockchain network to request to add into a block for storage.

Embodiments of the present disclosure provide a post-processing method based on copyright registration information, and the method is applied to a node of a blockchain network. The method includes: receiving a transaction request sent by a copyright service platform; and processing participant information and post-processing information of the copyright registration information in the transaction request, and adding the information processed into a block for storage.

Embodiments of the present disclosure provide a post-processing apparatus based on copyright registration information, and the apparatus is configured in a copyright service platform. The apparatus includes a registration information obtaining module, an operation information obtaining module, and an operation information sending module. The registration information obtaining module is configured to obtain the copyright registration information. The operation information obtaining module is configured to obtain at least two participant information and post-processing information of a copyright post-processing operation based on the copyright registration information. The operation information sending module is configured to send the at least two participant information and the post-processing information as a transaction request into a blockchain network to request to add into a block for storage.

Embodiments of the present disclosure provide a post-processing apparatus based on copyright registration information, and the apparatus is configured in a node of a blockchain network. The apparatus includes a transaction request receiving module and a processing storage module. The transaction request receiving module is configured to receive a transaction request sent by a copyright service platform. The processing storage module is configured to process participant information and post-processing information of the copyright registration information in the transaction request, and to add the information processed in a block for storage.

Embodiments of the present disclosure also provide a device. The device includes one or more processors and a storage device. The storage device is configured to store one or more programs. When the one or more programs are executed by the one or more processors, the one or more processors are caused to implement the post-processing method based on copyright registration information according to any of embodiments of a first aspect.

Embodiments of the present disclosure also provide a device. The device includes one or more processors and a storage device. The storage device is configured to store one or more programs. When the one or more programs are executed by the one or more processors, the one or more processors are caused to implement the post-processing method based on copyright registration information according to any of embodiments of a second aspect.

Embodiments of the present disclosure also provide a medium having a computer program stored thereon. When computer program is executed by a processor, causes the post-processing method based on copyright registration information according to any of embodiments of a first aspect to be implemented.

Embodiments of the present disclosure also provide a medium having a computer program stored thereon. When computer program is executed by a processor, causes the post-processing method based on copyright registration information according to any of embodiments of a second aspect to be implemented.

Other aspects may be understood after accompanying drawings and detailed description are read and understood.

### BRIEF DESCRIPTION OF THE DRAWINGS

FIG. 1 is a flow chart of a post-processing method based on copyright registration information according to Embodiment 1 of the present disclosure.

FIG. 2 is a flow chart of a post-processing method based on copyright registration information according to Embodiment 2 of the present disclosure.

FIG. 3 is a flow chart of a post-processing method based on copyright registration information according to Embodiment 3 of the present disclosure.

FIG. 4 is a flow chart of a post-processing method based on copyright registration information according to Embodiment 4 of the present disclosure.

FIG. 5 is a flow chart of a post-processing method based on copyright registration information according to Embodiment 5 of the present disclosure.

FIG. 6 is a flow chart of a post-processing method based on copyright registration information according to Embodiment 6 of the present disclosure.

FIG. 7 is a flow chart of a post-processing method based on copyright registration information according to Embodiment 7 of the present disclosure.

FIG. 8A is a block diagram of a post-processing blockchain system for copyright registration information applicable to Embodiment 8 of the present disclosure.

FIG. 8B is a flow chart of a post-processing method based on copyright registration information according to Embodiment 8 of the present disclosure.

FIG. 9 is a block diagram of a post-processing apparatus based on copyright registration information according to Embodiment 9 of the present disclosure.

FIG. 10 is a block diagram of a post-processing apparatus based on copyright registration information according to Embodiment 10 of the present disclosure.

FIG. 11 is a block diagram of a device according to Embodiment 11 of the present disclosure.

### DETAILED DESCRIPTION

The present disclosure will be described in detail below with reference to the accompanying drawings and the embodiments. It should be understood that, the specific embodiments described herein are only used to explain the present disclosure rather than to limit the present disclosure. In addition, it should also be noted that, for convenience of description, only part but not all structures related to the present disclosure are illustrated in the accompanying drawings.

### Embodiment 1

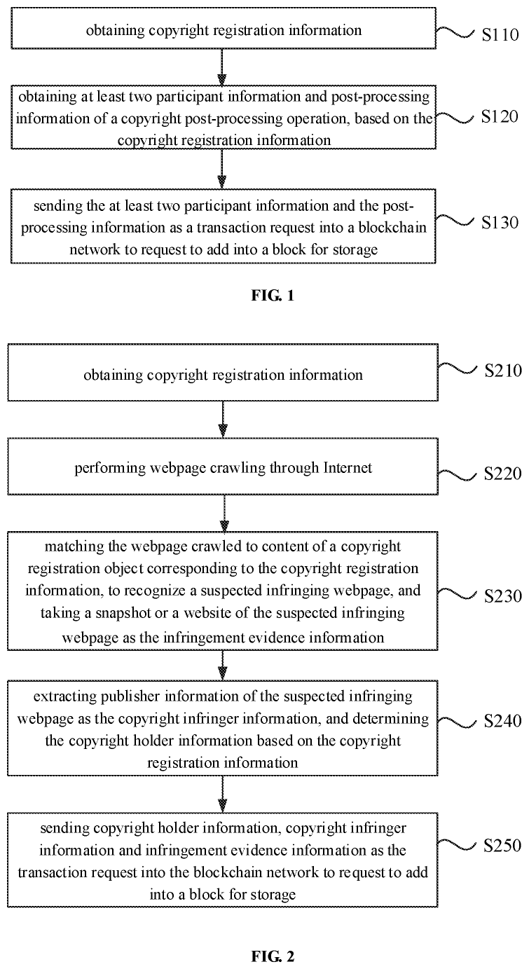

FIG. 1 is a flow chart of a post-processing method based on copyright registration information according to Embodiment 1 of the present disclosure. The embodiment may be applicable to post-processing operations of copyright registration information such as copyright transaction and copyright protection, and may be particularly to the scenes where the post-processing operation such as the copyright transaction and the copyright protection are not public, and processing efficiency and credibility are low. The entire post-processing method based on the copyright registration information may generally be executed in cooperation with a copyright service platform and a blockchain system. The blockchain may be a public chain or an alliance chain. The copyright service platform may be a server platform specially used for a user to register copyright information. Alternatively, the copyright service platform may be a totem platform that can interact with nodes and clients in the blockchain network. Correspondingly, the copyright registration information may be image copyright registration information. The solution according to embodiments of the present disclosure may be applied to the copyright service platform. The method may be executed by a post-processing apparatus based on copyright registration information according to embodiments of the present disclosure. The apparatus may be implemented in the form of software and/or hardware. Referring to FIG. 1, the method includes the following acts.

At block S110, copyright registration information is obtained.

The copyright registration information refers to information configured to prove the copyright author's ownership for the copyright registration content. Alternatively, the copyright registration information may include encrypted copyright author information and copyright content abstract; or the encrypted copyright author information, the copyright content abstract and trusted timestamp information.

The encrypted copyright author information is generated by encrypting creator information input by the user. The copyright author information includes but is not limited to: name, ID (identity) card, passport, organization name, organization certificate number, etc. The copyright content abstract is generated by performing abstract extraction on the copyright content. The trusted timestamp information refers to a timestamp file configured to represent that the copyright author owns the copyright of the copyright content.

The copyright registration information may also include: the encrypted copyright author information, the copyright content abstract, the trusted timestamp information and copyright content description information. The copyright content description information refers to the overall description or the summary of central idea of the creative content, which is optional content.

In detail, the copyright service platform may obtain, based on the blockchain address and the block number of the copyright registration information stored in the copyright service platform and required for post-processing operation, the copyright registration information from the blockchain network, and the copyright service platform may also obtain the copyright registration information from the client configured in the copyright service platform through the user input.

At block S120, at least two participant information and post-processing information of a copyright post-processing operation are obtained based on the copyright registration information.

The copyright post-processing operation refers to the operation performed by the copyright author after copyright registration and confirmation. The copyright post-processing operation may include copyright transaction operations such as copyright assignment and permission, and may also include copyright protection operations and other operations. The participant information may include but is not limited to: the name, the ID card, the passport, the organization name, the organization certificate number, etc. The post-processing information is information of the copyright post-processing operation. Exemplarily, different copyright post-processing operations correspond to different post-processing information.

When the copyright post-processing operation is the copyright protection operation, the post-processing information of the copyright post-processing operation is copyright protection information. Alternatively, obtaining the at least two participant information and the post-processing information of the copyright post-processing operation based on the copyright registration information may include acts of: obtaining copyright holder information, copyright infringer information and infringement evidence information of the copyright protection operation based on the copyright registration information. The copyright holder is the copyright author. Correspondingly, the copyright infringer refers to the party illegally using the copyright content of the copyright author without the permission of the copyright author. The infringement evidence information may include the infringement time, the infringement content and the infringement evidence website address, etc.

In detail, when the copyright service platform receives that any user submits a work to be protected through the copyright service platform or a client interface (such as a browser interface or an application interface on the client) and initiates a copyright protection request, the copyright service platform may obtain the copyright registration information from the blockchain network based on the information of the work to be protected and the address stored in the blockchain, determine the copyright holder information based on the copyright registration information, determine the infringement evidence information by performing operations such as webpage crawling, recognition matching, user confirmation based on the copyright registration information, and determine the copyright infringer information based on the infringement evidence information.

When the copyright post-processing operation is the copyright transaction operation, the post-processing information of the copyright post-processing operation may be the copyright transaction information. Alternatively, obtaining the at least two participant information and the post-processing information of the copyright post-processing operation based on the copyright registration information may include acts of: obtaining purchaser information, seller information and transaction processing information of a copyright transaction processing based on the copyright registration information. The transaction processing information may include transaction object information, transaction time information, and transaction amount information. The seller is the copyright author. Correspondingly, the purchaser is the party who purchases the copyright content or the copyright of the copyright author. The transaction object information refers to the information of the trading work.

In detail, when there is a transaction between the copyright author and the purchaser who needs to use or to purchase the work, a transaction request including the information of the work to be traded may be initiated to the copyright service platform. After the transaction request is received, the copyright service platform may obtain the copyright registration information of the work to be traded from the blockchain network based on the information of the work to be traded and the address stored in the blockchain, determine the seller information based on the copyright registration information, and determine the purchaser information and the transaction processing information based on the transaction request of the information of the work to be traded and the copyright registration information.

It should be noted that, the copyright transaction operation may also be organized by the copyright service platform. In detail, the copyright service platform may display the information of the work to be traded to the user, and use advanced intelligent image recognition technologies such as accurate image understanding, graphic understanding to intelligently understand, recognize, and automatically generate labels, thereby facilitating the user to query the target image. When the copyright service platform detects that the user purchases any work that can be traded, it may obtain the copyright registration information from the blockchain network based on the information of the work and the address stored in the blockchain, and determine the seller information, the purchaser information and the transaction processing information based on the copyright registration information.

At block S130, the at least two participant information and the post-processing information are sent as a transaction request into a blockchain network to request to add into a block for storage.

In detail, the copyright service platform may perform corresponding processing such as encryption on the at least two participant information and the post-processing information as the transaction request, and transmit the transaction request to the blockchain network to instruct indicating a block generation node in the blockchain network to store the transaction request in the blockchain.

Exemplarily, different copyright post-processing operations may have different ways of determining the transaction request, and there may also be different ways of determining the transaction request for the same copyright post-processing operation. Following embodiments may describe several methods for determining the transaction request based on the copyright transaction information and the copyright protection information, and sending the transaction request in the blockchain network to request to add into the block for storage.

With the technical solution according to embodiments of the present disclosure, the copyright service platform sends the information of the copyright post-processing operation as the transaction request into the blockchain network for storage, such that the information of the copyright post-processing operation is transparent to the copyright service platform and the trading parties, and cannot be tampered with, thereby weakening the power of the copyright service center, and ensuring the credibility, accuracy and transparency of the information of the copyright post-processing operation. In addition, since the information of the copyright post-processing operation maintains its credibility through the blockchain technology, it may better use Internet resources, and simplify the process of the post-processing operation, thereby improving the processing efficiency of the post-processing of the copyright registration information.

### Embodiment 2

FIG. 2 is a flow chart of a post-processing method based on copyright registration information according to Embodiment 2 of the present disclosure. On the basis of the above embodiments, the embodiments make further description for obtaining copyright holder information, copyright infringer information and infringement evidence information of a copyright protection operation based on the copyright registration information when the copyright post-processing operation is the copyright protection operation. Referring to FIG. 2, the method includes the following acts.

At block S210, copyright registration information is obtained.

At block S220, webpage crawling is performed through the Internet.

In detail, when the copyright service platform receives that any user submits a work to be protected through the copyright service platform or the client interface (such as a browser interface or an application interface on the client) and initiates a copyright protection request, the copyright service platform may recognize the work to be protected based on intelligent image recognition and other functions, determine the crawling target based on the recognition result, and crawl the webpage on the Internet according to the crawling target.

At block S230, the webpage crawled is matched to content of a copyright registration object corresponding to the copyright registration information, to recognize a suspected infringing webpage, and a snapshot or a website of the suspected infringing webpage is taken as the infringement evidence information.

The snapshot is a quick way to read all content, including the website URL of the current webpage, included in the current webpage.

In detail, content in the crawled webpage is matched to the content of the copyright registration object corresponding to the copyright registration information. The crawled webpage is determined as the suspected infringing webpage, when the match is successful or the matching degree reaches a preset threshold value such as 80%. In order to reduce the probability of fraud on the copyright service platform and to improve authenticity and reliability of the evidence, the copyright service platform may take the snapshot of the suspected infringing webpage or the website of the webpage as the infringement evidence information, such that the block generation node may, based on the website of the webpage or the website included in the snapshot, access the network to intercept the webpage, and retain it as the evidence, thereby ensuring that the evidence stored in the blockchain is actually available from the Internet.

At block S240, publisher information of the suspected infringing webpage is extracted as the copyright infringer information, and the copyright holder information is determined based on the copyright registration information.

The publisher refers to a user who publishes relevant content on the webpage. The publisher of the suspected infringing webpage is a user who publishes a content highly similar to the copyright registration object of the copyright author on the webpage.

In detail, after the suspected infringing webpage included in the Internet is identified through webpage crawling, and the website of the webpage is determined as the infringement evidence information, the copyright service platform may obtain publisher account information of the infringing content included in the webpage based on the suspected infringing webpage, and obtain the publisher information based on the publisher account information, and determine the publisher information as the copyright infringer information. Moreover, the information of the copyright author is determined as the copyright holder information based on the obtained copyright registration information.

At block S250, the copyright holder information, the copyright infringer information, and the infringement evidence information are sent as the transaction request into the blockchain network to request to add into the block for storage.

In detail, the copyright service platform may processes the copyright protection information, i.e., the copyright holder information and the copyright infringer information, and the infringement evidence information, and transmits it as the transaction request to the blockchain network to instruct the block generation node in the blockchain network to store the transaction request in the blockchain.

Exemplarily, sending the copyright holder information, the copyright infringer information, and the infringement evidence information as the transaction request into the blockchain network to request to add into the block for storage includes acts of: adding the copyright holder information, the copyright infringer information and the infringement evidence information to a first intelligent contract as the transaction request, and sending the transaction request into the blockchain network. The infringement evidence information is the website, and the first intelligent contract is configured to request the block generation node to obtain the suspected infringing webpage from the Internet based on the website, and add the suspected infringing webpage into the block for storage.

The first intelligent contract includes executable code segments configured to control the functions executable by the block generation node.

In detail, the copyright service platform adds the copyright protection information to the first intelligent contract as the transaction request, and sends the transaction request into the blockchain network. After the block generation node in the blockchain network receives the transaction request, it may, based on the website in the first intelligent contract, access the network to intercept the webpage, and store the webpage intercepted in the blockchain as the infringement evidence information.

With the technical solution according to embodiments of the present disclosure, the copyright protection information is sent as the transaction request to the blockchain network for storage, such that the copyright protection information is transparent to the copyright service platform, the copyright infringer and the copyright holder, and may not be tampered with, thereby weakening the power of the copyright service center, and ensuring the credibility, accuracy and transparency of the copyright protection information. In addition, since the copyright protection information is implemented based on the blockchain technology, problems that the copyright protection evidence is difficult to obtain and the authenticity is difficult to guarantee can be solved, and the process of the post copyright protection can be simplified, thereby improving the processing efficiency of the copyright protection operation.

### Embodiment 3

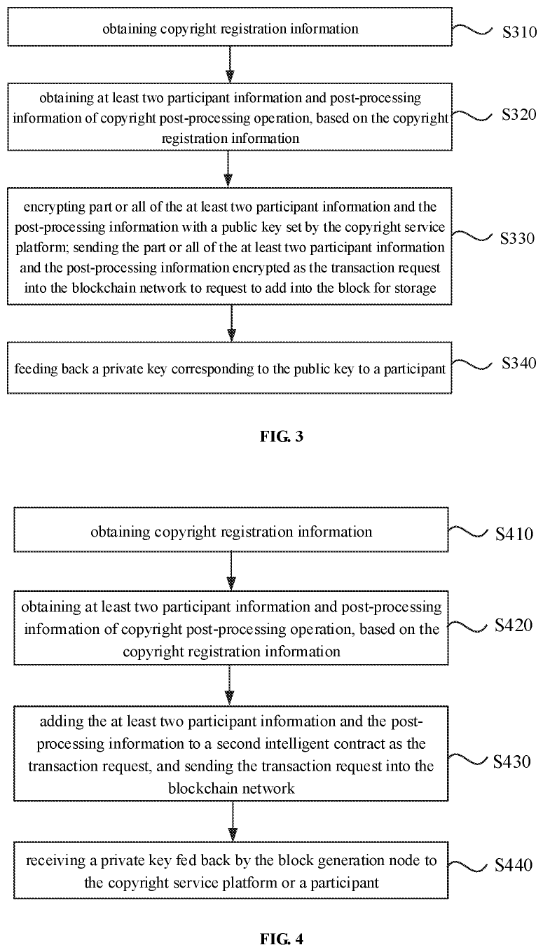

FIG. 3 is a flow chart of a post-processing method based on copyright registration information according to Embodiment 3 of the present disclosure. On the basis of the above embodiments, the embodiments make further description for sending the participant information and the post-processing information as the transaction request into the blockchain network to request to add into the block for storage when the copyright post-processing operation is a copyright transaction operation. Referring to FIG. 3, the method includes the following acts.

At block S310, copyright registration information is obtained.

At block S320, at least two participant information and post-processing information of the copyright post-processing operation are obtained, based on the copyright registration information.

At block S330, part or all of the at least two participant information and the post-processing information are encrypted with a public key set by the copyright service platform, the part or all of the at least two participant information and the post-processing information encrypted are sent as the transaction request into the blockchain network to request to add into the block for storage.

The participant information is the purchaser information and the seller information. The post-processing information is transaction processing information. The transaction processing information may include transaction object information, transaction time information, and transaction amount information.

In detail, due to the openness and transparency of the blockchain record information, in order to protect the security of copyright transaction information, the copyright service platform may encrypt part or all of the purchaser information, the seller information and the transaction processing information such as the transaction amount information, with the public key in an asymmetric key pair randomly generated or fixedly set by the copyright service platform, and transmit the encryption result as the transaction request into the blockchain network, such that the block generation node in the blockchain network stores the transaction request in the blockchain.

At block S340, a private key corresponding to the public key is fed back to a participant.

Since the asymmetric encryption public key and the asymmetric encryption private key appear in pairs, when the asymmetric encryption public key is used for encryption, the asymmetric encryption private key needs to be used for decryption. Therefore, in order to enable the participant to query the information involved in the copyright transaction operation, the copyright service platform needs to feed back the private key corresponding to the public key to the participant after the copyright service platform encrypts part or all of the participant information and the post-processing information with the public key set by the copyright service platform.

Exemplarily, when there are other users who have the right to query the information, the copyright service platform may also feed back the private key corresponding to the public key to the user who has the permission.

With the technical solution according to embodiments of the present disclosure, the copyright service platform encrypts, with the public key set by the copyright service platform, the copyright transaction information as the transaction request, and sends the transaction request to the blockchain network for storage, such that the copyright transaction information is transparent to the copyright service platform and the trading parties, and may not be tampered with, thereby weakening power of the copyright service center and ensuring the credibility, accuracy and transparency of the copyright transaction information.

In order to further ensure the security of the information of both parties involved in the transaction, the copyright service platform may also encrypt the part or all of the participant information and the post-processing information by using a public key provided by the participant. Exemplarily, sending the participant information and the post-processing information as the transaction request into the blockchain network to request to add into the block for storage includes acts of: encrypting part or all of the participant information and the post-processing information with a public key provided by at least one participant; and sending the part or all of the participant information and the post-processing information encrypted as the transaction request into the blockchain network to request to add into the block for storage.

In detail, the copyright service platform may send a public key providing message to the participants, i.e., the purchaser and the seller, to cause the purchaser and the seller to respectively provide his/her public key in the asymmetric key pair to the copyright service platform. The copyright service platform may use the public key of the purchaser and/or the seller to encrypt part or all of the participant information and the post-processing information, and send the encrypted result as the transaction request into the blockchain network for storage.

It is possible to encrypt part or all of the participant information and the post-processing information by using the public keys of the purchaser and the seller, respectively, to form two encrypted information, and the two encrypted information may be sent as two different transaction requests into the blockchain network for storage, to allow different users having the permissions to inquire and learn.

It is also possible to encrypt part of the participant information and the post-processing information or encrypt different parts of all the information by using the public keys of the purchaser and the seller. For example, the participant information may be encrypted by using the public key of the purchaser, and part or all of the post-processing information may be encrypted by using the public key of the seller.

Correspondingly, since the copyright transaction information is encrypted by using the public key of the purchaser and/or the seller, any user or the copyright service platform can view the encrypted information only when one or two of the purchaser and/or the seller agree and provide the private key, which ensures the privacy of both parties and the security of transaction information.

With the technical solution according to embodiments of the present disclosure, the copyright service platform encrypts the copyright transaction information by using the public key of the participants as the transaction request, the security of the information of both trading parities can be furthered ensured, and by sending the transaction request into the blockchain network for storage, such that the copyright transaction information is transparent to the copyright service platform and both parties of the transaction, and may not be tampered with, thereby weakening the power of the copyright service center and ensuring the credibility, accuracy and transparency of the copyright transaction information.

### Embodiment 4

FIG. 4 is a flow chart of a post-processing method based on copyright registration information according to Embodiment 4 of the present disclosure. On the basis of the above embodiments, the embodiments also provide a method for sending the participant information and the post-processing information as the transaction request into the blockchain network to request to add into the block for storage when the copyright post-processing operation is the copyright transaction operation. Referring to FIG. 4, the method includes the following acts.

At block S410, copyright registration information is obtained.

At block S420, at least two participant information and post-processing information of copyright post-processing operation are obtained, based on the copyright registration information.

At block S430, the participant information and the post-processing information are added to a second intelligent contract as the transaction request, and the transaction request is sent into the blockchain network.

The second intelligent contract is configured to request the block generation node to generate an asymmetric key pair, and encrypt part or all of the participant information and the post-processing information by using a public key. The participant information is the purchaser information and the seller information. The post-processing information is the transaction processing information. The transaction processing information may include the transaction object information, the transaction time information, and the transaction amount information.

In detail, in order to further improve the credibility of transaction information processing, and improve the efficiency of the copyright post-processing operation, the copyright service platform may directly add the copyright transaction information, i.e., the purchaser information and the seller information, and the transaction processing information, to the second intelligent contract as the transaction request, and transmit the transaction request to the blockchain network, such that the block generation node automatically generates the asymmetric key pair based on executable codes of the second intelligent contract in the transaction request, and encrypts the part or all of the participant information and the post-processing information with the public key.

At block S440, a private key fed back by the block generation node to the copyright service platform or the participant is received.

In detail, the copyright service platform may receive the private key fed back by the block generation node to the user having the permission such as the purchaser and the seller, and forward the private key to the corresponding user.

With the technical solution according to embodiments of the present disclosure, the copyright service platform directly adds the copyright transaction information to the second intelligent contract, such that the block generation node generates the asymmetric key pair based on the rule of the second intelligent contract, and encrypts the copyright transaction information by using the public key, and stores it. Thus, the credibility of the copyright transaction information can be improved, and the efficiency of the post copyright transaction operation can be improved. Moreover, the power of the copyright service center can be weakened, and the credibility, accuracy and transparency of the copyright transaction information can be ensured.

Exemplarily, sending the participant information and the post-processing information as the transaction request into the blockchain network to request to add into the block for storage may also include acts of: adding the participant information and the post-processing information to a third intelligent contract as the transaction request, and sending the transaction request into the blockchain network; receiving the private key providing message fed back by the block generation node, informing a participant to provide an asymmetric key pair based on the private key providing message, and forwarding the asymmetric key to the block generation node, to request the block generation node to encrypt part or all of the at least two participant information and the post-processing information based on a public key of the asymmetric key pair.

The third intelligent contract is configured to request the block generation node to feed back the private key providing message. The private key providing message refers to information for indicating the copyright service platform to provide the private key to the block generation node. Alternatively, the private key providing message may include the information of the user that needs to provide the private key, such as the seller information and/or the purchaser information.

In detail, the copyright service platform adds the copyright transaction information to the third intelligent contract as the transaction request, and transmits the transaction request to the blockchain network, such that the block generation node feeds back the private key providing message to the copyright service platform based on the rule of the third intelligent contract in the transaction request. After the private key providing message fed back by the block generation node is received, the copyright service platform may inform the corresponding participants to provide the asymmetric key pair based on the information of the participant that needs to provide the asymmetric key pair in the private key providing message, and forwards the asymmetric key pair to the block generation node, such that the block generation node encrypts part or all of the participant information and the post-processing information by using the public key in the asymmetric key pair.

With the technical solution according to embodiments of the present disclosure, the copyright service platform directly adds the copyright transaction information to the third intelligent contract, such that the block generation node feeds back the private key providing message to the copyright service platform based on the rule of the third intelligent contract, and encrypts and stores the copyright transaction information by using the public key of the participant fed back by the copyright service platform. Thus, the credibility of the copyright transaction information can be improved, and the efficiency of the post copyright transaction operation can be improved. Moreover, the power of the copyright service center can be weakened, and the credibility, accuracy and transparency of the copyright transaction information can be ensured.

### Embodiment 5

FIG. 5 is a flow chart of a post-processing method based on copyright registration information according to Embodiment 5 of the present disclosure. On the basis of the above embodiments, the embodiments also provide a method for sending the participant information and the post-processing information as the transaction request into the blockchain network to request to add into the block for storage when the copyright post-processing operation is the copyright transaction operation. Referring to FIG. 5, the method may include the following acts.

At block 510, copyright registration information is obtained.

At block 520, at least two participant information and post-processing information of copyright post-processing operation are obtained based on the copyright registration information

At block 530, part or all of the participant information and the post-processing information are signed and encrypted, the part or all of the at least two participant information and the post-processing information signed and encrypted are sent as the transaction request into the blockchain network to request to add into the block for storage.

The participant information is the purchaser information and the seller information. The post-processing information is the transaction processing information. The transaction processing information may include the transaction object information, the transaction time information, and the transaction amount information.

In detail, the copyright service platform may encrypt part or all of the purchaser information, the seller information, and the transaction processing information by using a signature algorithm such as SHA256 or md5sum, and transmit the information encrypted as the transaction request to the blockchain network, such that the block generation node adds the transaction request to the blockchain.

Exemplarily, after the part or all of the participant information and the post-processing information are signed and encrypted, and the part or all of the participant information and the post-processing information signed and encrypted are sent as the transaction request into the blockchain network to request to add into the block for storage, the method may further include acts of receiving a block address of the transaction request stored in the blockchain fed back by the block generation node.

At block 540, an information inquiry interface or a post-processing authorization certificate is provided to a participant.

The information inquiry interface or the post-processing authorization certificate is configured to enable the participant to query and obtain the participant information and the post-processing information from the blockchain network based on the signature algorithm. The information inquiry interface may be a virtual IP (Internet Protocol) interface or an interface for the copyright service platform to interact with the blockchain network. The post-processing authorization certificate is configured to indicate that the user has the right to view the copyright transaction information, for example, it may be a certificate authority (CA) certificate.

In detail, the copyright service platform may provide the copyright transaction information inquiry interface or the copyright transaction certificate, and the block address where the copyright transaction information is stored in the blockchain to both trading parties, and the trading parties can verify the authenticity of the copyright transaction information based on the blockchain and according to plaintext information and the encryption rule of the transaction.

With the technical solution according to embodiments of the present disclosure, the copyright transaction information is stored in the blockchain network, and the information inquiry interface or the post-processing authorization certificate is provided to the participant, such that the copyright transaction information is transparent to the copyright service platform and the trading parties, and may not be tampered with, thereby weakening the power of the copyright service center, and ensuring the credibility, accuracy and transparency of the copyright transaction information.

### Embodiment 6

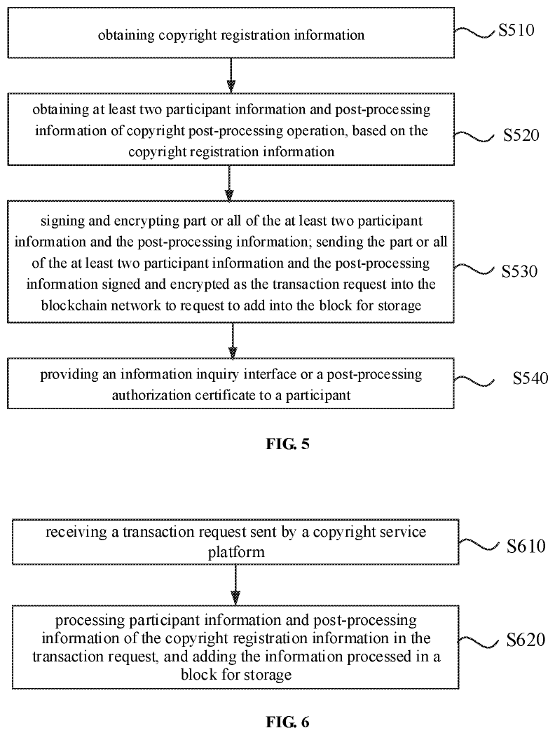

FIG. 6 is a flow chart of a post-processing method based on copyright registration information according to Embodiment 6 of the present disclosure. The entire post-processing method based on the copyright registration information may generally be executed in cooperation with the copyright service platform and the blockchain system. The blockchain may be a public chain or an alliance chain. The copyright service platform may be a server platform specially used for a user to register copyright information. Alternatively, the copyright service platform may be a totem platform that can interact with nodes and clients in the blockchain network. Correspondingly, the copyright registration information may be image copyright registration information. The solution according to embodiments of the present disclosure may be applied to a block generation node. The method may be executed by a post-processing apparatus based on copyright registration information according to embodiments of the present disclosure. The apparatus may be implemented in form of software and/or hardware. Referring to FIG. 6, the method includes the following acts.

At block S610, a transaction request sent by a copyright service platform is received.

The transaction request is obtained by the copyright service platform performing corresponding processing on the copyright post-processing operation information.

At block S620, participant information and post-processing information of the copyright registration information in the transaction request are processed, and the information processed is added into a block for storage.

The participant information and the post-processing information may be copyright holder information, copyright infringer information and infringement evidence information of a copyright protection operation, and participant information and the post-processing information may also be purchaser information, seller information and transaction processing information of a copyright transaction processing.

In detail, after the block generation node receives the transaction request including the participant information and the post-processing information sent by the copyright service platform, the block generation node may perform the processing operation such as encryption, information conversion, format adjustment or code execution on the transaction request to form transaction data, and add the transaction data in the block for storage.

Exemplarily, different copyright post-processing operations may correspond to different participant information and post-processing information, and different participant information and post-processing information correspond to different processing methods.

When the copyright post-processing operation is the copyright protection operation, the corresponding participant information and post-processing information may be the copyright holder information, the copyright infringer information and the infringement evidence information of the copyright protection operation. Alternatively, processing the participant information and the post-processing information of the copyright registration information in the transaction request and adding the information processed into the block for storage may include acts of: processing the copyright holder information, the copyright infringer information and the infringement evidence information of the copyright protection operation in the transaction request, and adding the information processed in the block for storage.

In detail, processing the copyright holder information, the copyright infringer information and the infringement evidence information of the copyright protection operation in the transaction request, and adding the information processed in the block for storage may include acts of: crawling, based on an obtained address of the infringement evidence information in the transaction request, a webpage through Internet as an infringement evidence; and processing the copyright holder information, the copyright infringer information and the infringement evidence of the copyright protection operation, and adding the copyright holder information processed, the copyright infringer information processed and the infringement evidence processed into the block for storage.

The obtained address may be the URL of the suspected infringing webpage. In detail, the block generation node may, based on the obtained address of the infringement evidence information in the transaction request, access the network to intercept the webpage as the infringement evidence, to ensure that the evidence stored in the blockchain is truly available from the webpage; and process the copyright holder information, the copyright infringer information and the infringement evidence information of the copyright protection operation as the new transaction request to form transaction data, and store the transaction data in the blockchain.

When the copyright post-processing operation is the copyright transaction operation, the corresponding participant information and post-processing information are the purchaser information, the seller information and the transaction processing information of copyright transaction processing. Alternatively, processing the participant information and the post-processing information of the copyright registration information in the transaction request and adding the information processed into the block for storage may include acts of: processing the purchaser information, the seller information and the transaction processing information of the copyright transaction processing in the transaction request, and adding the information processed into the block for storage.

With the technical solution according to embodiments of the present disclosure, the blockchain generation node processes the information of the copyright post-processing operation, and stores the processed information in the block, such that the information of the copyright post-processing operation is transparent to the copyright service platform and the trading parties, and may not be tampered with, thereby weakening the power of the copyright service center and ensuring the credibility, accuracy and transparency of the information of the copyright post-processing operation. In addition, since the information of the copyright post-processing operation is implemented based on the blockchain technology, and a procedure for the post-processing operation is simplified, thereby improving the processing efficiency of the post-processing operation of the copyright registration information.

### Embodiment 7

FIG. 7 is a flow chart of a post-processing method based on copyright registration information according to Embodiment 7 of the present disclosure. On the basis of the above embodiments, the embodiments provide a method for processing participant information and post-processing information of the copyright registration information in the transaction request, and adding the information processed into a block for storage, when the copyright post-processing operation is the copyright transaction operation. Referring to FIG. 7, the method includes the following acts.

At block S710, a transaction request sent by a copyright service platform is received.

At block S720, an asymmetric key pair is generated based on a second intelligent contract in the transaction request.

The second intelligent contract is a logical code segment, which can be used by the copyright service platform to request the block generation node to generate the asymmetric key pair and encrypt part or all of the participant information and the post-processing information by using the public key. In detail, after the transaction request sent by the copyright service platform is received, the block generation node generates the asymmetric key pair by running the transaction request.

At block S730, part or all of the participant information and the post-processing information is encrypted with a public key, and the part or all of the participant information and the post-processing information encrypted is added into the block for storage.

The participant information and the post-processing information are the purchaser information, the seller information and the transaction processing information of the copyright transaction processing.

In detail, the block generation node may encrypt part or all of the purchaser information, the seller information and the transaction processing information of the copyright transaction processing with the public key in the asymmetric key pair generated, and store the encrypted information in the block.

In order to facilitate the copyright service platform and the user having the permission such as the purchaser and the seller to inquire the copyright transaction information, exemplarily, after the encrypted information is added into the block for storage, the method may further include: feeding back the block address where the encrypted information is stored in the blockchain to the copyright service platform or the participant.

At block S740, a private key is fed back to the copyright service platform or a participant.

In detail, in order to facilitate the participant to query or prove the copyright transaction information, the block generation node may send the private key to the copyright service platform, and the copyright service platform may forward the private key to the participant. The block generation node may also directly send the private key to the participant through the participant's access to the virtual IP interface of the blockchain network.

With the technical solution according to embodiments of the present disclosure, the block generation node generates the asymmetric key pair based on the rule of the second intelligent contract, and encrypts the copyright transaction information with the public key, and stores the information encrypted. The credibility of the copyright transaction information is improved, and the efficiency of the copyright transaction operation is improved. Moreover, the power of the copyright service center is weakened, and the credibility, accuracy and transparency of the copyright transaction information are ensured.

Exemplarily, processing the participant information and the post-processing information of the copyright registration information in the transaction request, and adding the information processed into the block for storage may further include acts of: generating a private key providing message based on a third intelligent contract in the transaction request; sending the private key providing message to the copyright service platform, to cause the copyright service platform to inform the participant to provide an asymmetric key pair based on the private key providing message; and receiving a public key in the asymmetric key pair forwarded by the copyright service platform, encrypting part or all of the participant information and the post-processing information based on the public key, and adding the part or all of the participant information encrypted and the post-processing information encrypted into the block for storage.

The third intelligent contract includes a logic code segment configured to control the block generation node to feed back the private key providing message.

In detail, after the transaction request sent by the copyright service platform is received, the block generation node may feed back the private key providing message to the copyright service platform by running the transaction request based on the rule of the third intelligent contract in the transaction request. After the private key providing message fed back by the block generation node is received, the copyright service platform may inform the corresponding participant to provide the asymmetric key pair based on the information of the participant required to provide the asymmetric key pair in the private key providing message, and forward the asymmetric key pair to the block generation node. After the public key pair of the asymmetric key forwarded by the copyright service platform is received, the block generation node may encrypt the part or all of the participant information and the post-processing information with the public key, and store the encrypted information in the block.

With the technical solution according to embodiments of the present disclosure, the generation node feeds back the private key providing message to the copyright service platform based on the rule of the third intelligent contract, encrypts the copyright transaction information by using the public key of the participant fed back by the copyright service platform, and stores the encrypted information. The credibility of the copyright transaction information is improved, and the efficiency of the copyright transaction operation is improved. Moreover, the power of the copyright service center is weakened, and the credibility, accuracy and transparency of the copyright transaction information are ensured.

### Embodiment 8

On the basis of the above embodiments, embodiment 8 provides an exemplary solution for implementing post-processing of the copyright registration information based on the blockchain technology. Before the post-processing operation based on the copyright registration information is described in detail, an architecture of the blockchain system involved in the solution may be described firstly.

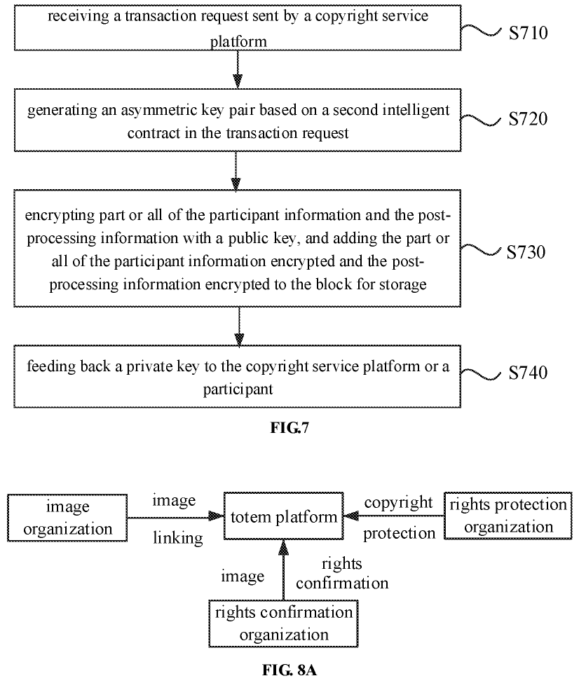

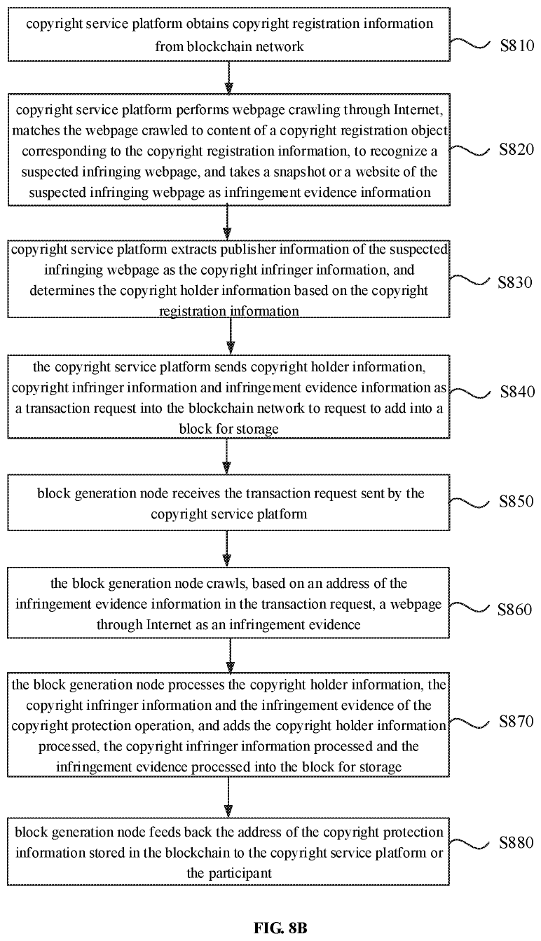

In detail, the system architecture for implementing the post-processing method of the copyright registration information may be illustrated in FIG. 8A, the architecture mainly includes an alliance chain formed by organization nodes, a totem platform and multiple clients. The alliance chain includes an alliance chain system formed by at least one blockchain network node provided by an image organization, a rights protection organization and a rights confirmation organization. The totem platform is a copyright service platform, which is configured to obtain the copyright registration information from the blockchain network. The node in the blockchain network is configured to receive the transaction request sent by the totem platform, and process participant information and post-processing information of the copyright registration information in the transaction request, and add the processed information into the block for storage.

The totem platform is a centralized server, which is responsible for interacting with various organization nodes and clients, and is a link between the two. The totem platform may also integrate third-party application functions, such as copyright feature extraction, image recognition and annotation, and other functions. The client is configured to allow the user to log in the totem platform for copyright registration, copyright protection and transaction operations. The client may issue its own copyright registration information through the totem platform, and generate copyright registration transaction data including at least copyright author information, copyright content abstract and timestamp information, to record in the blockchain. The blockchain system is configured to perform distributed recording on the copyright registration information, the copyright protection information and the copyright transaction information, such that the copyright registration information, the copyright protection information and the copyright transaction information are credible and transparent.

In the above solution, the participating nodes are the alliance nodes that form the alliance chain. The parties to which the node belongs may include, for example, an image organization, a rights confirmation organization, and a rights protection organization.

The image organization is represented by Visual China, ViewStock, Paixin, etc., which relies on Baidu's search traffic resources, and may also become the cooperation agent of Baidu totem image transaction platform, selling and agenting more images, and obtaining higher image sale profits.

The rights confirmation organization is represented by the copyright bureau, the copyright center, the timestamp, etc. The relevant data of copyright registration of the rights confirmation organization may be bundled together to the chain, its coverage can be extended, and its right confirmation standard or manner may cover more images, such that the right confirmation result may be recognized by the court.

The rights protection organization is represented by the Tudun, the notarial office, judicial authentication center, court, etc. When the platform issues a rights protection requirement, ownership and authorization information stored in the platform database may be queried by the copyright agency, and the copyright agency may solve the problem of rights confirmation through the totem platform, and obtain clear and comprehensive information on ownership, agency, and transaction.

In the following, as an example, the copyright protection operation in the post-processing based on the copyright registration information will be described below. Referring to FIG. 8B, following acts may be included.

At block S810, the copyright service platform obtains copyright registration information from the blockchain network.

At block S820, the copyright service platform performs webpage crawling through the Internet, matches the webpage crawled to content of a copyright registration object corresponding to the copyright registration information to recognize a suspected infringing webpage, and takes a snapshot or a website of the suspected infringing webpage as the infringement evidence information.

At block S830, the copyright service platform extracts publisher information of the suspected infringing webpage as the copyright infringer information, and determines the copyright holder information based on the copyright registration information.

At block S840, the copyright service platform sends the copyright holder information, the copyright infringer information and the infringement evidence information as a transaction request into the blockchain network to request to add into a block for storage.

At block S850, the block generation node receives the transaction request sent by the copyright service platform.

At block S860, the block generation node crawls, based on an address of the infringement evidence information in the transaction request, the webpage through Internet as an infringement evidence.

At block S870, the block generation node processes the copyright holder information, the copyright infringer information and the infringement evidence of the copyright protection operation, and adds the copyright holder information processed, the copyright infringer information processed and the infringement evidence processed into the block for storage.

At block S880, the block generation node feeds back the address where the copyright protection information is stored in the blockchain to the copyright service platform or the participant.

With the technical solution according to embodiments of the present disclosure, the copyright service platform sends the copyright protection information as the transaction request into the blockchain network for storage, such that the copyright protection information is transparent to the copyright service platform and both trading parties, and may not be tampered with, thereby weakening the power of the copyright service center, and ensuring the credibility, accuracy and transparency of the copyright protection information. In addition, since the copyright protection information is implemented based on the blockchain technology, problems that the protection evidence is difficult to obtain and the authenticity is difficult to guarantee can be solved, and the procedure for post-processing operation can be simplified, thereby improving the processing efficiency of the copyright protection operation.

### Embodiment 9

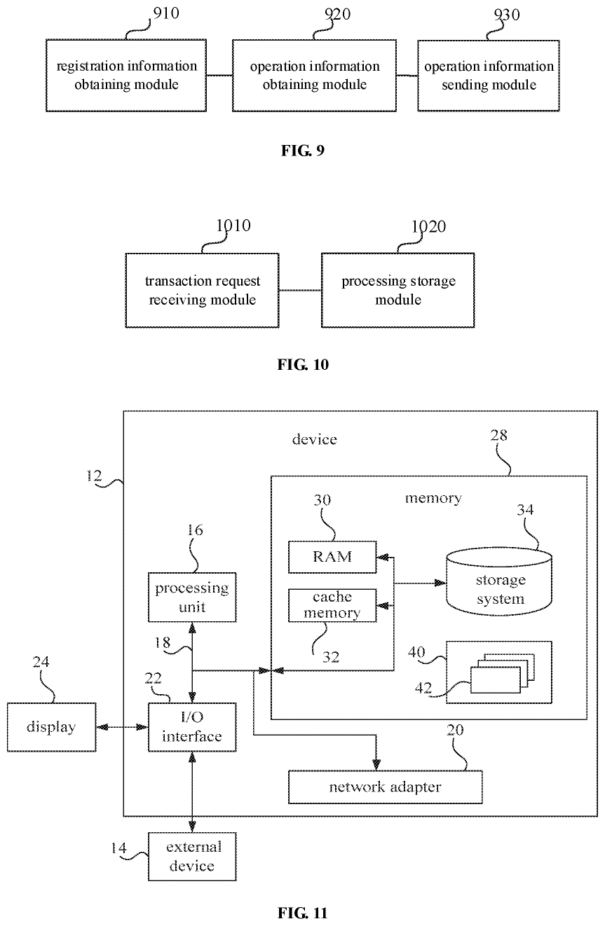

FIG. 9 is a block diagram of a post-processing apparatus based on copyright registration information according to Embodiment 9 of the present disclosure. The apparatus is configured in a copyright service platform, and may be configured to execute the post-processing method based on copyright registration information according to any one of embodiments 1-5 of the present disclosure, and have corresponding function modules configured to perform the method and have advantageous effects. As illustrated in FIG. 9, the apparatus includes a registration information obtaining module 910, an operation information obtaining module 920, and an operation information sending module 930.

The registration information obtaining module 910 is configured to obtain the copyright registration information.

The operation information obtaining module 920 is configured to obtain at least two participant information and post-processing information of a copyright post-processing operation based on the copyright registration information.

The operation information sending module 930 is configured to send the at least two participant information and the post-processing information as a transaction request into a blockchain network to request to add into a block for storage.

With the technical solution according to embodiments of the present disclosure, the copyright service platform sends the information of the copyright post-processing operation as the transaction request into the blockchain network for storage, such that the information of the copyright post-processing operation is transparent to the copyright service platform and the trading parties, and cannot be tampered with, thereby weakening the power of the copyright service center, and ensuring the credibility, accuracy and transparency of the information of the copyright post-processing operation. In addition, since the information of the copyright post-processing operation maintains its credibility through the blockchain technology, the process of the post-processing operation is simplified, thereby improving the processing efficiency of the post-processing of the copyright registration information.

Exemplarily, the operation information obtaining module 920 may also include a copyright protection information obtaining unit, which is configured to obtain copyright holder information, copyright infringer information and infringement evidence information of the copyright protection operation based on the copyright registration information.

Alternatively, the copyright protection information obtaining unit is configured to: perform webpage crawling through the Internet; match the webpage crawled to content of a copyright registration object corresponding to the copyright registration information, to recognize a suspected infringing webpage, and taking a snapshot or a website of the suspected infringing webpage as the infringement evidence information; and extract publisher information of the suspected infringing webpage as the copyright infringer information, and determining the copyright holder information based on the copyright registration information.

Alternatively, the operation information sending module 930 may include a copyright protection information sending unit, which is configured to add the copyright holder information, the copyright infringer information and the infringement evidence information to a first intelligent contract as the transaction request, and send the transaction request into the blockchain network. The infringement evidence information is the website, and the first intelligent contract is configured to request a block generation node to obtain the suspected infringing webpage from the Internet based on the website, and add the suspected infringing webpage into the block for storage.

Exemplarily, the operation information obtaining module 920 may also include a transaction information obtaining unit, which is configured to obtain purchaser information, seller information and transaction processing information of a copyright transaction processing based on the copyright registration information. The transaction processing information includes transaction object information, transaction time information, and transaction amount information.

Alternatively, the operation information sending module 930 may include a transaction information sending unit, which is configured to encrypt part or all of the at least two participant information and the post-processing information with a public key set by the copyright service platform; send the part or all of the participant information and the post-processing information encrypted as the transaction request into the blockchain network to request to add into the block for storage; and feed back a private key corresponding to the public key to a participant.

Exemplarily, the transaction information sending unit is further configured to encrypt part or all of the at least two participant information and the post-processing information with a public key provided by at least one participant, and send the part or all of the at least two participant information and the post-processing information encrypted as the transaction request into the blockchain network to request to add into the block for storage.

Exemplarily, the transaction information sending unit is further configured to: add the at least two participant information and the post-processing information to a second intelligent contract as the transaction request, and send the transaction request into the blockchain network; encrypt part or all of the at least two participant information and the post-processing information with a public key; and receive a private key fed back by the block generation node to the copyright service platform or a participant. The second intelligent contract is configured to request a block generation node to generate an asymmetric key pair.

Exemplarily, the transaction information sending unit is further configured to add the at least two participant information and the post-processing information to a third intelligent contract as the transaction request, and send the transaction request in the blockchain network; receive the private key providing message fed back by the block generation node, inform a participant to provide an asymmetric key pair based on the private key providing message, and forward the asymmetric key pair to the block generation node, to request the block generation node to encrypt part or all of the at least two participant information and the post-processing information based on a public key of the asymmetric key pair. The third intelligent contract is configured to request a block generation node to feed back a private key providing message.

Exemplarily, the transaction information sending unit is further configured to sign and encrypt part or all of the at least two participant information and the post-processing information; send the part or all of the at least two participant information and the post-processing information signed and encrypted as the transaction request into the blockchain network to request to add into the block for storage; and provide an information inquiry interface or a post-processing authorization certificate to a participant. The information inquiry interface or the post-processing authorization certificate is configured to enable the participant to query and obtain the at least two participant information and the post-processing information from the blockchain network based on a signature algorithm.

### Embodiment 10

FIG. 10 is a block diagram of a post-processing apparatus based on copyright registration information according to Embodiment 10 of the present disclosure. The apparatus is configured in a node of a blockchain network, and may be configured to execute the post-processing method based on copyright registration information according to any one of embodiments 6-7 of the present disclosure, and have corresponding function modules configured to perform the method, and have advantageous effects. As illustrated in FIG. 10, the apparatus includes: a transaction request receiving module 1010 and a processing storage module 1020.

The transaction request receiving module 1010 is configured to receive a transaction request sent by a copyright service platform.

The processing storage module 1020 is configured to process participant information and post-processing information of the copyright registration information in the transaction request, and adding the information processed into a block for storage.

With the technical solution according to embodiments of the present disclosure, the blockchain generation node processes the information of the copyright post-processing operation, and stores the processed information in the block, such that the information of the copyright post-processing operation is transparent to the copyright service platform and the trading parties, and may not be tampered with, thereby weakening the power of the copyright service center and ensuring the credibility, accuracy and transparency of the information of the copyright post-processing operation. In addition, since the information of the copyright post-processing operation is implemented based on the blockchain technology, and a procedure for the post-processing operation is simplified, thereby improving the processing efficiency of the post-processing operation of the copyright registration information.

It should be noted that, in the embodiment, the participant information and the post-processing information may be copyright holder information, copyright infringer information and infringement evidence information of a copyright protection operation, and may also be purchaser information, seller information and transaction processing information of copyright transaction processing.

Alternatively, the processing storage module 1020 may include a transaction processing storage unit. The transaction processing storage unit is configured to generate an asymmetric key pair based on a second intelligent contract in the transaction request; encrypt part or all of the participant information and the post-processing information with a public key, and add the part or all of the participant information encrypted and the post-processing information encrypted into the block for storage; and feedback a private key to the copyright service platform or a participant.

Alternatively, the transaction processing storage unit is further configured to: generate a private key providing message based on a third intelligent contract in the transaction request; send the private key providing message to the copyright service platform, to cause the copyright service platform to inform the participant to provide an asymmetric key pair based on the private key providing message; and receive a public key in the asymmetric key pair forwarded by the copyright service platform, encrypt part or all of the participant information and the post-processing information based on the public key, and add the part or all of the participant information and the post-processing information encrypted into the block for storage.

Alternatively, the processing storage module 1020 may also include a copyright protection processing storage unit. The copyright protection processing storage unit is configured to crawl, based on an address of the infringement evidence information in the transaction request, a webpage through Internet as an infringement evidence; and process the copyright holder information, the copyright infringer information and the infringement evidence of the copyright protection operation, and add the copyright holder information processed, the copyright infringer information processed and the infringement evidence processed into the block for storage.

### Embodiment 11

FIG. 11 is a block diagram of a device according to Embodiment 11 of the present disclosure. FIG. 11 illustrates a block diagram of an exemplary device applicable to implement implementations of the present disclosure. The device 12 illustrated in FIG. 11 is only an example, which may not bring any limitation to functions and scope of embodiments of the present disclosure.

As illustrated in FIG. 11, the device 12 is presented in form of a general-purpose computing device. Components of the device 12 may include but be not limited to: one or more processors or processing units 16, a system memory 28, and a bus 18 connecting different system components (including the system memory 28 and the processor 16).

The bus 18 represents one or more of several bus structures, including a storage bus or a local bus with any bus structure in the plurality of bus structures and being employed by a storage controller, a peripheral bus, an accelerated graphics port and a processor. For example, these architectures include, but are not limited to, an industry standard architecture (ISA) bus, a micro channel architecture (MCA) bus, an enhanced ISA bus, a video electronics standards association (VESA) local bus and a peripheral component interconnection (PCI) bus.

The device 12 typically includes a plurality of computer system readable mediums. These mediums may be any usable medium that may be accessed by the device 12, including volatile and non-volatile mediums, removable and non-removable mediums.

The system memory 28 may include computer system readable mediums in the form of volatile medium, such as a random-access memory (RAM) 30 and/or a cache memory 32. The device 12 may further include other removable/non-removable, volatile/non-volatile computer system storage mediums. Only as an example, the storage system 34 may be configured to read from and write to non-removable, non-volatile magnetic mediums (not illustrated in FIG. 11, and usually called “a hard disk driver”). Although not illustrated in FIG. 11, a magnetic disk driver configured to read from and write to the removable non-volatile magnetic disc (such as “a diskette”), and an optical disc driver configured to read from and write to a removable non-volatile optical disc (such as a compact disc-read only memory (CD-ROM), a digital video disc-read only memory (DVD-ROM) or other optical mediums) may be provided. Under these circumstances, each driver may be connected to the bus 18 by one or more data medium interfaces. The system memory 28 may include at least one program product. The program product has a set of program modules (such as, at least one program module), and these program modules are configured to execute functions of respective embodiments of the present disclosure.

A program/utility tool 40, having a set (at least one) of program modules 42, may be stored in the system memory 28. Such program modules 42 include, but not are limited to, an operating system, one or more application programs, other program modules, and program data. Each or any combination of these examples may include an implementation of a network environment. The program module 42 usually executes functions and/or methods described in embodiments of the present disclosure.

The device 12 may communicate with one or more external devices 14 (such as a keyboard, a pointing device, and a display 24), may also communicate with one or more devices enabling a user to interact with the device 12, and/or may communicate with any device (such as a network card, and a modem) enabling the device 12 to communicate with one or more other computing devices. Such communication may occur via an input/output (I/O) interface 22. Moreover, the device 12 may further communicate with one or more networks (such as local area network (LAN), wide area network (WAN) and/or public network, such as Internet) via a network adapter 20. As illustrated in FIG. 11, the network adapter 20 communicates with other modules of the device 12 via the bus 18. It should be understood that, although not illustrated in FIG. 11, other hardware and/or software modules may be used in combination with the device 12, including but being not limited to: microcode, device drivers, redundant processing units, external disk drive arrays, RAID (redundant array of independent disks) systems, tape drives, and data backup storage systems, etc.

The processor 16, by operating programs stored in the system memory 28, executes various function applications and data processing, for example implements the post-processing method based on copyright registration information according to embodiments of the present disclosure. The device is typically as a copyright service platform.

### Embodiment 12

Embodiment 12 provides a device according to embodiments of the present disclosure, and used for executing the post-processing method based on the copyright registration information according to any one of embodiments 6-7 of the present disclosure. The device includes one or more processors and a storage device. The storage device is configured to store one or more programs. When the one or more programs are executed by the one or more processors, the one or more processors are caused to implement the post-processing method based on copyright registration information according to any one of embodiments 6-7 of the present disclosure. The device is applied to a node of a blockchain network. The device is typically a computing device that carries the function of the node of the blockchain network. The detailed structure and details may be referred to FIG. 11 and Embodiment 11.

### Embodiment 13

Embodiment 13 of the present disclosure also provides a computer readable storage medium having a computer program stored thereon. When the computer program is executed by a processor, the post-processing method based on copyright registration information according to any one of the above embodiments 1-5 is implemented.

The computer readable medium of embodiments of the present disclosure may employ any combination of one or more computer readable mediums. The computer readable medium may be a computer readable signal medium or a computer readable storage medium. The computer readable storage medium may be, such as, but not limited to an electronic, magnetic, optical, electromagnetic, infrared, or semiconductor system, apparatus or device, or any suitable combination of the foregoing. More specific examples (a non-exhaustive list) of the computer readable storage medium may include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical memory device, a magnetic memory device, or any appropriate combination of the foregoing. In this document, the computer readable storage medium may be any tangible medium that contains or stores a program. The program may be used by or in conjunction with an instruction execution system, apparatus or device.

The computer readable signal medium may include a data signal transmitted in the baseband or as a part of a carrier, in which computer readable program codes are carried. The transmitted data signal may employ a plurality of forms, including but not limited to, an electromagnetic signal, a light signal or any suitable combination thereof. The computer readable signal medium may further be any computer readable medium other than the computer readable storage medium. The computer readable medium may send, propagate or transmit programs configured to be used by or in combination with an instruction execution system, apparatus or device.

The program codes included in the computer readable medium may be transmitted by any appropriate medium, including but not limited to wireless, electric wire, optical cable, RF (Radio Frequency), or any suitable combination of the foregoing.

The computer program codes for executing operations of the present disclosure may be programmed using one or more programming languages or the combination thereof. The programming languages include object-oriented programming languages, such as Java, Smalltalk, C++, and include conventional procedural programming languages, such as the C programming language or similar programming languages. The program codes may be executed entirely on a user computer, partly on the user computer, as a stand-alone software package, partly on the user computer and partly on a remote computer, or entirely on the remote computer or server. In the scenario involving the remote computer, the remote computer may be connected to the user computer through any type of network, including a local area network (LAN) or a wide area network (WAN), or may be connected to an external computer (for example, through the Internet using an Internet service provider).

### Embodiment 14

Embodiment 14 of the present disclosure also provide a computer readable storage medium having a computer program stored thereon. When the computer program is executed by a processor, the post-processing method based on copyright registration information according to any one of the above embodiments 6-7 is implemented. Detailed description for the embodiment may be referred to description for Embodiment 13.

Although a specific illumination is made to the present disclosure by the above embodiments, the present disclosure is not merely limited to the above embodiments. More other equivalent embodiments may also be included without departing from the technical idea of the present disclosure. The scope of the present disclosure is determined by the appended claims.

1. A post-processing method based on copyright registration information, applied to a copyright service platform, and comprising:
obtaining the copyright registration information;
obtaining at least two participant information and post-processing information of a copyright post-processing operation, based on the copyright registration information; and
sending the at least two participant information and the post-processing information as a transaction request into a blockchain network to request to add into a block for storage.

2. The method of claim 1, wherein obtaining the at least two participant information and the post-processing information of the copyright post-processing operation based on the copyright registration information comprises:

3. The method of claim 2, wherein obtaining the copyright holder information, the copyright infringer information, and infringement evidence information of the copyright protection operation based on the copyright registration information comprises:
performing webpage crawling through Internet;
matching the webpage crawled to content of a copyright registration object corresponding to the copyright registration information, to recognize a suspected infringing webpage, and taking a snapshot or a website of the suspected infringing webpage as the infringement evidence information; and
extracting publisher information of the suspected infringing webpage as the copyright infringer information, and determining the copyright holder information based on the copyright registration information.

4. The method of claim 2, wherein sending the copyright holder information, the copyright infringer information, and the infringement evidence information as the transaction request into the blockchain network to request to add into the block for storage comprises:
adding the copyright holder information, the copyright infringer information and the infringement evidence information to a first intelligent contract as the transaction request, and sending the transaction request into the blockchain network,
wherein the infringement evidence information is the website, and the first intelligent contract is configured to request a block generation node to obtain the suspected infringing webpage from the Internet based on the website, and add the suspected infringing webpage into the block for storage.

5. The method of claim 1, wherein obtaining the at least two participant information and the post-processing information of the copyright post-processing operation based on the copyright registration information comprises:
obtaining purchaser information, seller information and transaction processing information of a copyright transaction processing based on the copyright registration information, wherein the transaction processing information comprises: transaction object information, transaction time information, and transaction amount information.

6. The method of claim 1, wherein sending the at least two participant information and the post-processing information as the transaction request into the blockchain network to request to add into the block for storage comprises:
encrypting part or all of the at least two participant information and the post-processing information with a public key set by the copyright service platform;
sending the part or all of the at least two participant information and the post-processing information encrypted as the transaction request into the blockchain network to request to add into the block for storage; and
feeding back a private key corresponding to the public key to a participant.

7. The method of claim 1, wherein sending the at least two participant information and the post-processing information as the transaction request into the blockchain network to request to add into the block for storage comprises:
encrypting part or all of the at least two participant information and the post-processing information with a public key provided by at least one participant; and
sending the part or all of the at least two participant information and the post-processing information encrypted as the transaction request into the blockchain network to request to add into the block for storage.

8. The method of claim 1, wherein sending the at least two participant information and the post-processing information as the transaction request into the blockchain network to request to add into the block for storage comprises:
adding the at least two participant information and the post-processing information to a second intelligent contract as the transaction request, and sending the transaction request into the blockchain network, wherein the second intelligent contract is configured to request a block generation node to generate an asymmetric key pair;
encrypting part or all of the at least two participant information and the post-processing information with a public key; and
receiving a private key fed back by the block generation node to the copyright service platform or a participant.

9. The method of claim 1, wherein sending the at least two participant information and the post-processing information as the transaction request into the blockchain network to request to add into the block for storage comprises:
adding the at least two participant information and the post-processing information to a third intelligent contract as the transaction request, and sending the transaction request into the blockchain network, wherein the third intelligent contract is configured to request a block generation node to feed back a private key providing message;
receiving the private key providing message fed back by the block generation node, informing a participant to provide an asymmetric key pair based on the private key providing message, and forwarding the asymmetric key pair to the block generation node, to request the block generation node to encrypt part or all of the at least two participant information and the post-processing information based on a public key of the asymmetric key pair.

10. The method of claim 1, wherein sending the at least two participant information and the post-processing information as the transaction request into the blockchain network to request to add into the block for storage comprises:
signing and encrypting part or all of the at least two participant information and the post-processing information;
sending the part or all of the at least two participant information and the post-processing information signed and encrypted as the transaction request into the blockchain network to request to add into the block for storage; and
providing an information inquiry interface or a post-processing authorization certificate to a participant, wherein the information inquiry interface or the post-processing authorization certificate is configured to enable the participant to query and obtain the at least two participant information and the post-processing information from the blockchain network based on a signature algorithm.

11. A post-processing method based on copyright registration information, applied to a node of a blockchain network, comprising:
receiving a transaction request sent by a copyright service platform; and
processing participant information and post-processing information of the copyright registration information in the transaction request, and adding the information processed into a block for storage.

12. The method of claim 11, wherein the participant information and the post-processing information comprise:
copyright holder information, copyright infringer information, and infringement evidence information of a copyright protection operation; or purchaser information, seller information, and transaction processing information of a copyright transaction processing.

13. The method of claim 11, wherein processing the participant information and the post-processing information of the copyright registration information in the transaction request, and adding the information processed into the block for storage comprises:
generating an asymmetric key pair based on a second intelligent contract in the transaction request;
encrypting part or all of the participant information and the post-processing information with a public key, and adding the part or all of the participant information and the post-processing information encrypted into the block for storage; and
feeding back a private key to the copyright service platform or a participant.

14. The method of claim 11, wherein processing the participant information and the post-processing information of the copyright registration information in the transaction request, and adding the information processed into the block for storage comprise:
generating a private key providing message based on a third intelligent contract in the transaction request;
sending the private key providing message to the copyright service platform, to cause the copyright service platform to inform the participant to provide an asymmetric key pair based on the private key providing message; and
receiving a public key in the asymmetric key pair forwarded by the copyright service platform, encrypting part or all of the participant information and the post-processing information based on the public key, and adding the part or all of the participant information and the post-processing information encrypted into the block for storage.

15. The method of claim 12, wherein processing the copyright holder information, the copyright infringer information and the infringement evidence information of the copyright protection operation in the transaction request, and adding the information processed into the block for storage comprise:
crawling, based on an address of the infringement evidence information in the transaction request, a webpage through Internet as an infringement evidence; and
processing the copyright holder information, the copyright infringer information and the infringement evidence of the copyright protection operation, and adding the copyright holder information processed, the copyright infringer information processed and the infringement evidence processed into the block for storage.

16.-17. (canceled)

18. A device, comprising:
one or more processors; and
a storage device, configured to store one or more programs,
wherein when the one or more programs are executed by the one or more processors, the one or more processors are caused to:
obtain the copyright registration information;
obtain at least two participant information and post-processing information of a copyright post-processing operation, based on the copyright registration information; and
send the at least two participant information and the post-processing information as a transaction request into a blockchain network to request to add into a block for storage.

19-21. (canceled)

22. The device according to claim 18, wherein the one or more processors are further configured to:
obtain copyright holder information, copyright infringer information and infringement evidence information of a copyright protection operation, based on the copyright registration information.

23. The device according to claim 22, wherein the one or more processors are further configured to:
perform webpage crawling through Internet;
match the webpage crawled to content of a copyright registration object corresponding to the copyright registration information, to recognize a suspected infringing webpage, and take a snapshot or a website of the suspected infringing webpage as the infringement evidence information; and
extract publisher information of the suspected infringing webpage as the copyright infringer information, and determining the copyright holder information based on the copyright registration information.

24. The device according to claim 22, wherein the one or more processors are further configured to:
add the copyright holder information, the copyright infringer information and the infringement evidence information to a first intelligent contract as the transaction request, and send the transaction request into the blockchain network,
wherein the infringement evidence information is the website, and the first intelligent contract is configured to request a block generation node to obtain the suspected infringing webpage from the Internet based on the website, and add the suspected infringing webpage into the block for storage.

25. The device according to claim 18, wherein the one or more processors are further configured to:
obtain purchaser information, seller information and transaction processing information of a copyright transaction processing based on the copyright registration information, wherein the transaction processing information comprises: transaction object information, transaction time information, and transaction amount information.
